(19) United States
(12) Patent Application Publication
(10) Pub. No.: US 2011/0073053 A1
(43) Pub. Date: Mar. 31, 2011

(54) METHOD FOR CAM-SHAFT PHASE SHIFTING CONTROL USING CAM REACTION FORCE

(75) Inventor: Xiaolan Ai, Massillon, OH (US)

(73) Assignee: KOYO BEARINGS USA LLC, Westlake, OH (US)

(21) Appl. No.: 12/845,030

(22) Filed: Jul. 28, 2010

Related U.S. Application Data
(60) Provisional application No. 61/247,229, filed on Sep. 30, 2009.

(51) Int. Cl. F16D 3/10; F01L 1/344

(52) U.S. Cl. 123/90.15

(57) ABSTRACT

A control method for an electro-mechanical camshaft phase shifting devices in general, and a control method for an electro-mechanic camshaft phase shifting device with a self-locking mechanism in particular. The control method takes advantage of a cam shaft reaction torque in conjunction with a frictional self-locking feature of an electro-mechanical camshaft phase shifting device to simplify the control structure and to reduce the actuating torque required for the associated electric machine, consequently reducing the size of electric machine.

### CLAIM OF PRIORITY

This application claims priority to U.S. Provisional Application Ser. No. 61/247,229, filed Sep. 30, 2009, the entire disclosure of which is incorporated by reference herein.

### CROSS-REFERENCE TO RELATED APPLICATIONS

The present application is related to U.S. patent application Ser. No. 12/441,841 filed on Mar. 18, 2009 as a U.S. National Stage of PCT/US2007/078755 filed on Sep. 18, 2007 and published as WO 2008/036650 A1.

The present application is related to U.S. patent application Ser. No. 12/517,920 filed on Jun. 5, 2009 as a U.S. National Stage of PCT/US2007/024822 filed on Dec. 4, 2007 and published as WO 2008/070066 A1.

The present application is related to U.S. Provisional Patent Application Ser. No. 60/978,568 filed on Oct. 9, 2007.

The present application is related to U.S. Provisional Patent Application Ser. No. 61/121,694 filed on Dec. 11, 2008.

### STATEMENT REGARDING FEDERALLY SPONSORED RESEARCH

Not Applicable.

### BACKGROUND OF THE INVENTION

The present invention is related generally to a camshaft adjustment mechanism for use in an internal combustion engine, and in particular, to a control structure utilizing cam reaction torque to control an electro-mechanical camshaft phase shifting device.

Camshaft phase shifting devices are used more often in gasoline engines to vary valve timing for benefits of improving fuel economy and exhaust gas quality. There are many types of cam shaft phase shifting devices. Hydraulic cam phase shifting devices are commonly seen current applications. The major challenges for these hydraulic cam phasers include obtaining required slew rate in slow-speed operation, maintaining accurate cam shaft angular position, and extending the range of operating temperature. To reduce high pollutant emissions, it is highly desirable to adjust cam phase angle before or during engine startup. This requires the cam-shaft phase shifting device to be controlled prior to or during engine startup. These difficulties can be overcome by electro-mechanical cam-shaft phase shifting devices.

In International Patent Cooperation Treaty Application Ser. No. PCT/US2007/078755, an electro-mechanical camshaft phase shifting device (eCPS) is disclosed. The device includes a three-shaft gear unit and an electric machine. The three shaft gear unit, comprising an input shaft, an output shaft and a control shaft, features a frictional self-locking mechanism. The output shaft is locked to the input shaft unless torque is applied to the control shaft. Upon receiving command from the engine ECU, the electric machine, connected to the control shaft, can be operated in three modes to achieve desired performance objectives. The three operating modes include the neutral mode in which the electric machine exerts no torque on the control shaft, the motoring mode in which the electric machine exerts a driving torque on the control shaft, and the generating mode in which the electric machine exerts braking torque on the control shaft.

Similarly, in International Patent Cooperation Treaty Application Ser. No. PCT/US2007/024822, a control structure for a electro-mechanical camshaft phase shifting device is disclosed. The control structure uses both feed forward and feed back loops to generate control signals for the electric machine, and thus provides a concrete means for an eCPS to realize the three different operating modes.

### BRIEF SUMMARY OF THE INVENTION

Briefly stated, the present disclosure provides a control method for an electromechanical camshaft phase shifting device in general, and a control method for an electro-mechanic camshaft phase shifting device with a self-locking mechanism in particular. The control method takes advantage of cam shaft reaction torque in conjunction with the frictional self-locking feature of the eCPS to simplify the control structure and to reduce the actuating torque required for the electric machine, consequently reducing the size of electric machine.

The camshaft phase shifting device of the present disclosure includes a coaxially arranged three-shaft gear system, having an input shaft, an output shaft and a control shaft for adjusting the phase angle between the input and output shafts. The input shaft is coupled with the engine crank shaft, the output shaft is coupled with the cam shaft, and the control shaft is coupled with the rotator of an electric machine. The method of control is developed from a so-called torque-time based control structure. The dynamic response of the system, and thus the desired phase angle of the cam shaft, is controlled and maintained by a controller that produces a torque command with a constant amplitude and variable width based on a signal or signals it receives. The signal or signals received includes a cam shaft phase angle error signal, defined as the deviation of cam phase shift angle from a reference value. The torque command (a voltage signal for example) is then converted by an electric machine into an electro-magnetic torque exerted on the control shaft of the camshaft phase shifting device. The length in time during which the torque is applied is determined by the pulse width of the torque command.

In one embodiment of the present disclosure, the torque command can be a signed constant whose amplitude is changeable based on the cam shaft speed in either a continuous or stepwise fashion.

In one embodiment of the present disclosure, the torque command may be smaller than the amplitude of a camshaft reaction torque reflected on the control shaft.

In one embodiment of the present disclosure, the controller includes an on-and-off switch to turn off the torque command for energy savings when a self-locking mechanism is determined to be active.

The foregoing features and advantages set forth in the present disclosure, as well as presently preferred embodiments, will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 schematically illustrates a control structure of the present disclosure for controlling an electro-mechanical cam phase shifting device;

FIG. 2 illustrates the interconnections between an input shaft, an output shaft, a control shaft, and a three-coaxial shaft gearing system of the present disclosure;

FIG. 3 illustrates a sectional view of an electro-mechanical camshaft phase shifting device with the three-coaxial shaft gearing system;

FIG. 4 illustrates a plot of the torque, phase angle shifting speed, and shifting angle of the output shaft with respect to the input shaft; and

FIG. 5 schematically illustrates an alternate control structure of the present disclosure for controlling an electro-mechanical cam phase shifting device.

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

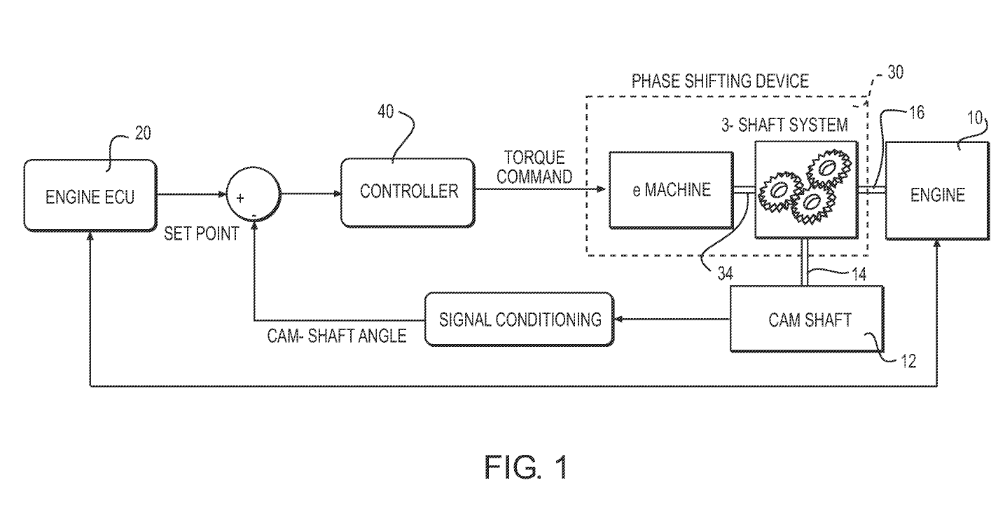

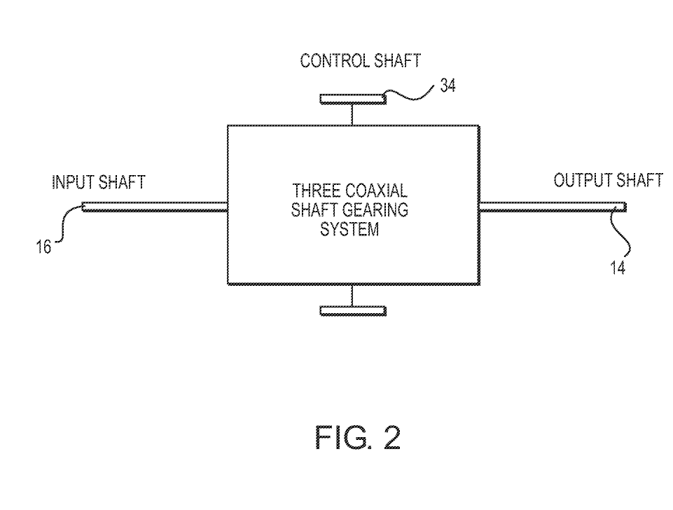

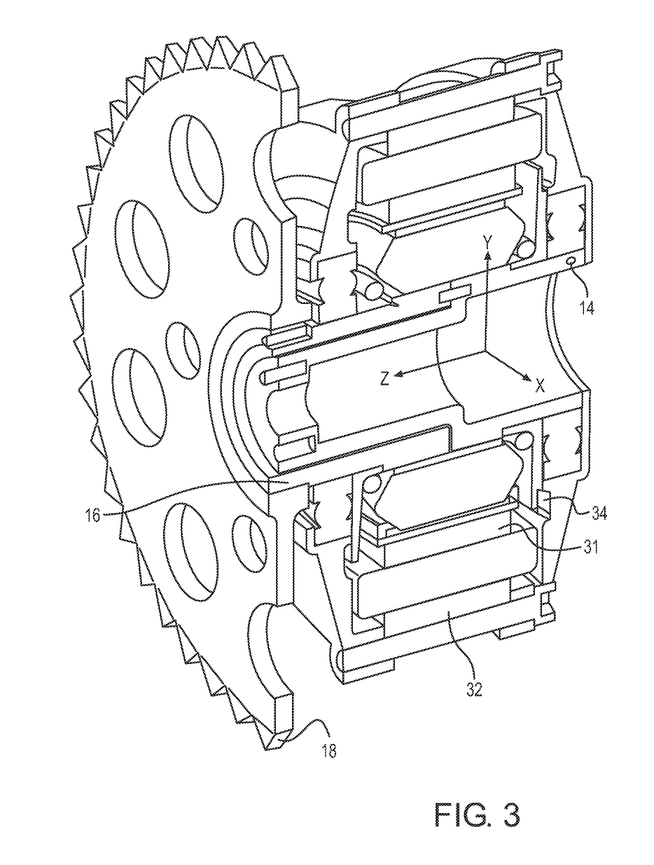

Turning to the Figures, and to FIG. 1 in particular, a control structure for controlling the electro-mechanical cam phase shifting device is shown. The system shown in FIG. 1 is comprised of an engine 10, an engine control unit (ECU) 20, a phase shifting device 30 and a controller 40. The phase shifting device 30 includes a three-shaft gearing system, having three co-axially arranged rotatable shafts as depicted in FIGS. 2 and 3. The input shaft 16 to the phase shifting device 30 is connected through a sprocket 18 and a chain drive (not shown) to the engine crank shaft. The output shaft 14 of the phase shifting device 30 is connected to the engine cam shaft 12. A control shaft 34 of the phase shifting device 30 is coupled to the rotor 31 of an electric machine 32.

The phase shifting device 30 has a built-in frictional self-locking mechanism, which enables the output shaft 14 to lock up with the input shaft 16 and therefore to transmit torque between the two shafts with a 1:1 speed ratio if no torque is applied to the control shaft 34. Under this condition, there will be no phase shift between input shaft 16 and output shaft 14. Frictional locking between the input shaft 16 and the output shaft 14 can only be unlocked by applying adequate torque to the control shaft 34.

During operation, the required torque to unlock the input shaft 16 from the output shaft 14 is generated by the electric machine 32 coupled to the control shaft 34 in response to a torque command received by the electric machine from the controller 40. When the phase shifting device 30 is unlocked, there may be a slight difference between the speed of the input shaft 16 and the output shaft 14. This allows the cam shaft 12 connected to the output shaft 14 to shift in angular position with respect to the input shaft 16.

The cyclical nature of the reactive torque to the cam shaft from valve springs in the engine 10 can be utilized in conjunction with the resistive nature of frictional torque from the self-locking mechanism to reduce the actuation torque required to be generated on the control shaft 34 by the electric machine 32.

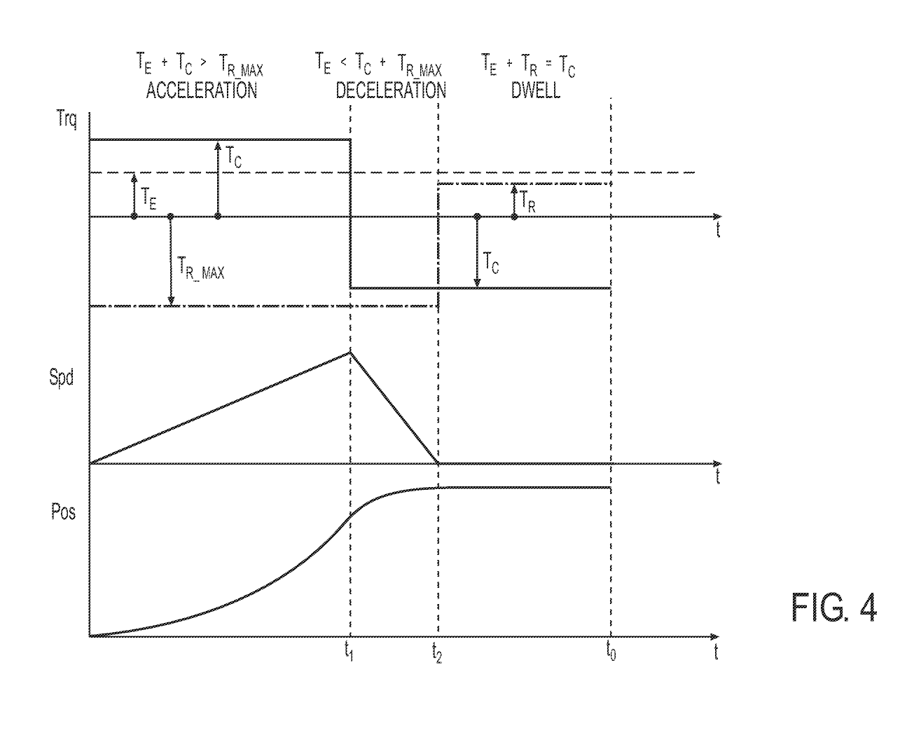

Turning to FIG. 4, it will be seen that T_{C} denotes the cam shaft reaction torque, T_{E} denotes the effective electric machine actuation torque, and T_{R} denotes the effective resistant torque. The phrase “effective” means the torque values are converted from their origins and are seen or measured on the cam shaft. The maximum frictional resistant torque can be reasonably expressed as T_{R—max}=qT_{C} where q>1, for the gear train to have a self-locking feature. Assume that the change in reaction torque T_{C} follows a square wave as shown in FIG. 4, and the actuation direction is the positive direction for torque and speed. To take the advantage of frictional resistant torque in reducing actuation torque, set

T_{E}<T_{C}

and chose q such that

T_{E}>(q−1)T_{C}.

Thus, when reaction torque T_{C} is aligned with actuation torque T_{E}, we have

ti T_{E}+T_{C}>qT_{C}=T_{R—max}

T_{E}+T_{C} will overcome T_{R—max} to unlock the gear train and accelerate the output shaft 14 with respect to the input shaft 16. Accordingly, the output shaft 14 starts to shift the phase angle in a positive direction. When reaction torque T_{C} changes direction, it works against actuation torque T_{E}. Since

T_{E}<T_{C}<T_{C}+T_{R—max},

T_{C} +T_{R—max} takes over T_{E} and slows output shaft 14 down with respect to input shaft 16 until it reaches the same speed as the input shaft 16. During deceleration, the output shaft 14 continues to phase with respect to the input shaft 16 in the positive direction at a decreasing rate until the phase difference becomes zero. At this moment the resistant torque T_{R} reverses direction and assists T_{E} to maintain the balance between the actuation torque T_{E} and the reaction torque T_{C}, that is

T_{E}+T_{R}=T_{C}.

The output shaft 14 does not change phase with respect to the input shaft 16 until the reaction torque T_{C} becomes positive again during the next cycle. FIG. 4 illustrates the torque, phase angle shifting speed, and shifting angle of the output shaft 14 with respect to the input shaft 16. Three regimes are identified for each cycle of reaction torque T_{C} during actuation. They are respectively referred to as the acceleration regime, the deceleration regime, and the dwell regime. The phase angle shift per cycle varies with the amplitude of actuation torque T_{E}, and the cumulative phase angle shifted during the actuation is a function of both the amplitude and duration of the actuation torque T_{E}. This forms the basis for torque-time based control structure.

In real applications, the variation of reaction torque T_{C} does not follow an ideal square wave form, and the transitions between the dwell and acceleration regimes and between the acceleration and deceleration regimes may not coincide with the zero-crossing point of the reaction torque T_{C}. However, this does not alter the torque-time based control structure.

To implement the torque-time based control structure of the present disclosure, the controller 40 generates a torque command, which can be a voltage signal, based on information it receives from the engine ECU 20 and the cam shaft angle sensors. The received information includes, but is not limited to, a cam shaft phase shift angle set point (reference), and an actual cam shaft phase shift angle measured and/or computed from angular position sensor signals. The actual cam shaft phase shift angle is compared to the reference value to generate a differential (error) signal. The differential or error signal is then fed to a compensator to generate a torque command with an amplitude restricted not to exceed a chosen value for T_{E}. This value can be lower than the maximum reaction torque T_{C} but has to be higher than the differential between the maximum frictional torque and the maximum reaction torque. In applications, the amplitude of chosen actuation torque T_{E} may be adjusted to suite for engine speed or other conditions. The duration of the actuation torque command is controlled by a timing logic in the controller 40, and is based on error signal or signals.

The torque command generated by the controller 40 is in turn used to command the electric machine for controlling and adjusting the cam shaft phase angle to decrease the error signal or signals sent to the controller 40. In doing so, the desired cam shaft phase shift is achieved.

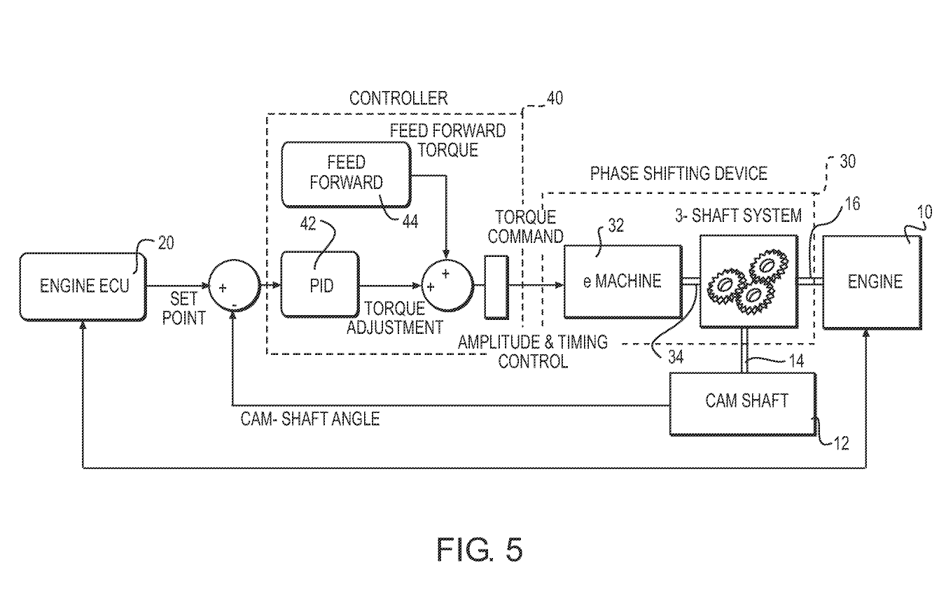

Optionally, the torque-time based controller 40 may further include a PID compensator 42, as shown in FIG. 5. The compensator can be primarily a proportional-and-derivative controller (PD). In addition, as is further shown in FIG. 5, the controller 40 may further include a feed forward branch (or a processor) 44 for processing and computing an anticipated torque disturbance. The resulting signal is fed forward to, and combined with, the output signal of the PID controller, forming the base for the torque command signal controlling the operation of the electric machine 32.

Since, as described above, the phase shifting device 30 features a self-locking mechanism, it is possible to turn the controller 40 and the electric machine 32 off for energy savings when the actual cam phase shift angle is in a close proximity to the desired value (reference value or set point). This is done, for example, by sending a signal from the controller 40 to the electric machine 32 commanding a zero torque output.

It is also possible to move the derivative portion of the PID compensator 42 to a feed back path to reduce the effects of impulse (sudden change) in reference input.

Those of ordinary skill in the art will recognize that the control system of the present disclosure may be implemented with other types of compensators using alternative control laws, such as model predictive controller (MPC), to replace the PID compensator 42.

The current invention may include other embodiments that can be derived from the current torque-time based control structure.

As various changes could be made in the above constructions without departing from the scope of the disclosure, it is intended that all matter contained in the above description or shown in the accompanying drawings shall be interpreted as illustrative and not in a limiting sense.

1. A camshaft phase shifting device comprising:
a coaxially arranged three-shaft gear system, having an input shaft receiving a driving torque from an engine, an output shaft transferring said driving torque to a cam shaft, and a control shaft, said control shaft configured to adjust a phase angle between said input shaft and said output shaft;
a controller operatively coupled to said control shaft, said controller responsive to at least one input signal to generate a torque command to regulate activation torque delivered to said control shaft from an electro-magnetic source of torque to overcome a frictional torque on said control shaft locking the phase angle of said input shaft relative to said output shaft; and
wherein said generated torque command is selected to regulate said activation torque delivered to said control shaft from said electro-magnetic source of torque such that the effective activation torque reflected on said cam shaft is less than a maximum reaction torque on said output shaft from said cam shaft, but greater than a difference between a maximum effective frictional torque as seen from cam shaft and said maximum reaction torque.

2. The camshaft phase shifting device of claim 1 wherein said controller operates with a torque-time based control structure.

3. The camshaft phase shifting device of claim 1 wherein said at least one input signal is selected from a set of input signals including, but not limited to, a cam shaft phase angle differential (error) signal, an engine speed signal, a torque load signal, an angular position signal of said cam shaft; and a relative speed signal between said input and output shafts.

4. The camshaft phase shifting device of claim 1 wherein said electromagnetic source of torque is an electric machine configured to exert said activation torque on said control shaft, said electric machine regulated by a torque command from said controller.

5. The camshaft phase shifting device of claim 1 wherein said torque command includes a feed-forward component to compensate for anticipated disturbances in system torques.

6. The camshaft phase shifting device of claim 1 wherein said torque command includes a feedback component to compensate for impulses (sudden changes) in said input signal.

7. The camshaft phase shifting device of claim 1 wherein said control shaft includes a friction self-locking mechanism configured to phase-lock said input shaft and said output shaft with said frictional torque in the absence of any activation torque from said electro-magnetic source of torque, said frictional self-locking mechanism transmitting said driving torque from said input shaft to said output shaft; and
wherein an application of said activation torque to said frictional self-locking mechanism selectively unlocks said phase angle of said input shaft relative to said output shaft.

8. The camshaft phase shifting device of claim 1 wherein said controller includes a PID compensator to generate a torque adjustment signal in response to said at least one input signal, said PID compensator consisting of a proportional-and-derivative controller; and
wherein said controller further includes a signal amplitude and timing control logic for receiving said torque adjustment signal and for generating said torque command to regulate activation torque delivered to said control shaft from said electro-magnetic source of torque.

9. The camshaft phase shifting device of claim 8 wherein said controller further includes a feed forward processing branch, said feed forward processing branch configured to evaluate anticipated torque disturbances and to generate a feed forward signal component for combination with said torque adjustment signal prior to generation of said torque command by said amplitude and timing control logic.

10. The camshaft phase shifting device of claim 1 wherein said reaction torque is cyclical, and wherein an amplitude of said torque command regulates said adjustment to said phase angle between said input shaft and said output shaft during a single reaction torque cycle.

11. The camshaft phase shifting device of claim 1 wherein a duration of said torque command regulates a total adjustment to said phase angle between said input shaft and said output shaft.

12. The camshaft phase shifting device of claim 1 wherein said phase angle adjustment accelerates in response to a combination of said effective activation torque and said reaction torque exceeding said maximum effective frictional torque;
wherein said phase angle adjustment decelerates in response to said effective activation torque being less than a combination of said reaction torque and said maximum effective frictional torque; and
wherein said phase angle adjustment remains unchanged (dwells) in response to a combination of said effective activation torque and said effective frictional torque equaling said reaction torque.

13. A method for torque-time controlled alteration of a camshaft phase angle for a camshaft driven though a camshaft phase shifting device having an input shaft receiving a driving torque, an output shaft delivering the driving torque, and a frictional locking control shaft for adjusting the phase angle between the input shaft and the output shaft, comprising:
regulating an activation torque applied to the control shaft to overcome a frictional locking torque to enable a phase angle adjustment between the input shaft and the output shaft, effective activation torque as seen from the cam shaft regulated to be less than a maximum cyclical reaction torque on the output shaft from the cam shaft, but greater than a difference between a maximum effective frictional torque locking said control shaft and said maximum cyclical reaction torque.

14. The method of claim 13 for torque-time controlled alteration of a camshaft phase angle wherein said step of regulating said activation torque applied to the control shaft is responsive to at least one input signal selected from a set of input signals including, but not limited to, a cam shaft phase angle error signal, a torque load signal, an angular position signal of the cam shaft, and a relative speed signal between the input and output shafts.
